(19) United States
(12) Patent Application Publication
(10) Pub. No.: US 2007/0115857 A1
(43) Pub. Date: May 24, 2007

(54) Mapping connectivity of discrete types of nodes in a network of nodes

(75) Inventor: Kevin J. Webster, Tigard, OR (US)

Correspondence Address: CANADY & LORTZ LLP- IBM, 2540 HUNTINGTON DRIVE, SUITE 205, SAN MARINO, CA, 91108, US

(73) Assignee: International Business Machines Corporation, San Jose, CA (US)

(21) Appl. No.: 11/284,724

(22) Filed: Nov. 21, 2005

(51) Int. Cl. H04L 12/28

(52) U.S. Cl. 370/254; 370/252

(57) ABSTRACT

Tables of connectivity between nodes of two discrete types can be generated for edge nodes existing at the periphery of a network of nodes. Connectivity queries are initiated at one of an interior node type and then traverse in a first direction towards one edge node type and then in a second direction towards the other edge node type. The traversals to the second edge node type are skipped if it is determined that there is no connectivity to the nodes on the first type of edge nodes. In addition, check tables of known connectivity between node types may be populated so that the same connectivity traversal is not attempted more than once. The number of connectivity traversals and the associated time costs can be significantly reduced when compared to conventional connectivity mapping techniques.

### BACKGROUND OF THE INVENTION

1. Field of the Invention

This invention relates to networked computer systems. Particularly, this invention relates to performing connectivity mapping of nodes in a network comprising computing devices such as storage devices.

2. Description of the Related Art

Interoperability, simplicity, and flexibility are critical considerations for those who manage storage. Accordingly, the management of storage area networks (SANs) using diverse protocols and components has been a source of difficulty for both end users and vendors alike. Various interoperability issues have been a consequence of the use of uncoordinated applications from multiple vendors, creating a complex management environment. The storage management initiative specification (SMI-S) represents an attempt to alleviate some of the associated problems.

The Storage Networking Industry Association (SNIA) developed SMI-S to address the interoperability management concerns for storage networks. In general, SMI-S was designed to make it easier for the hardware and software from different storage vendors to operate together. The specification is designed to replace the disparate protocols and transport technologies from multiple vendors with common models and common protocols, making it easier for developers to support devices from other vendors. The end result is a common management interface for network components that decreases the complexity of SAN management.

SMI-S is based on existing standards such as the common information model (CIM) and web-based enterprise management (WBEM). CIM describes the management requirements and capabilities of systems and WBEM specifies how they should be used. SMI-S also includes common interoperable and extensible management transport, automated discovery and resource locking, and is specific to storage management. When a new SMI-S component is introduced to a SAN, it will identify itself and its capabilities, and will then be able to properly share its resources with multiple entities in the network.

CIM provides a common definition of management information for systems, networks, applications and services, and allows for vendor extensions. CIM's common definitions enable vendors to exchange semantically rich management information between systems throughout a network. In general, CIM is a schema. The schema provides the actual model descriptions. WBEM is the specification that defines the details for CIM's integration with other management models.

In the prior art, when employing a network of nodes with discrete node types, it is often necessary to map connectivity of two or more types of nodes. Unfortunately, SMI-S suggests using lengthy association traversals in mapping network connectivity. However, traversing the network of CIM object nodes in this manner can take several hours in some situations.

FIG. 1A illustrates a typical connectivity mapping 100 as known in the art. Four node types 102, 104, 106, 108 are depicted conveniently arranged in a distinct column for each node type 102, 104, 106, 108. The connectivity mapping from nodes of type 1102 to nodes of type 4 108 can be summarized as: {1A, 4B}, {1B, 4B}, {1C, 4A}, {1C, 4B}, {1D, 4B} and {1E, 4B}. The connectivity mapping determines which nodes of type 1 102 at one end have a complete connection through to nodes of type 4 108 at the opposite end. In the prior art, the connectivity of nodes is mapped by starting at one type of node, determining the connected nodes, and following connections to the next type of node, and so forth. For example, a prior art system may begin at node 1A 110, determine that it is connected to node 2B 112, then determine that node 2B 112 is connected to node 3B 114, and then determine that node 3B 114 is connected to node 4B 116. A prior art system would then iterate through each remaining node of type 1 102, and follow connectivity paths to determine the indirect connections to nodes of type 4 108.

There is a time cost, i.e. a processing delay, for each occasion connectivity of a node to nodes of another type is determined. An example of this may be demonstrated with the CIM and SMI-S standards, where association traversals between CIM objects are costly in terms of time, due to a processing delay in the CIM Object Manager Server. The logical unit number (LUN) Masking and Mapping Subprofile in SMI-S provides a good example of a network of nodes, where determining connectivity between nodes in a timely fashion is important for SMI-S management applications.

FIG. 1B illustrates the operation of a conventional algorithm for connectivity mapping operating on the example network of FIG. 1A. Each numbered arrow represents a query which incurs a time cost. The queries are numbered in sequence as they occur in this example. Two arrows with the same number indicates that the connectivity is determined in the same query. For example, when the conventional algorithm reaches the node 3A 124, it queries for connected nodes of type 4 108. The results of this query indicates that 3A 124 is connected to 4A 126 and 4B 116. Thus, there is one time cost from that query (i.e., the 9th query), and that time cost is substantially similar to the time cost of any other query. However, two arrows with the same number are used to represent the cost of that query because the query found two connected nodes. Note that the conventional connectivity mapping algorithm queries node 3B connectivity to any type 4 108 nodes four times. Overall, in this example, the conventional connectivity mapping algorithm incurs a cost of nineteen queries for determining the connectivity between type 1 102 and type 4 108 nodes.

It is important to note that the time cost is a consequence of determining the node connectivity whether or not a connection is actually found. Thus, there is a time cost associated with determining connectivity of a node, even if it is found that the node is not connected to anything. For example, in the FIG. 1B there is a time cost that occurs when querying for which type 2 104 nodes are connected to node 1H 118. The result from this query is that there are no connected type 2 102 nodes, but a time cost for making the query occurs regardless of the outcome.

In addition, the conventional connectivity mapping algorithm may traverse the same connectivity association more than once, as illustrated in FIG. 1B. For example, the connection between node 2B 112 and node 3B 114 is traversed twice, a first time when determining connected nodes of node 1A 110 and a second time when determining connected nodes of node 1B 120.

In addition, the conventional connectivity mapping algorithm may also traverse connectivity associations, i.e. perform a connection queries, that are not necessary. For example, because node 2E 122 is not connected to any nodes of type 3 106, it is not necessary to query for type 1 102 nodes that are connected to 2E 122. However, the conventional connectivity mapping algorithm still performs such queries or traversals, incurring an unnecessary time cost, that finds the connectivity between type 1 102 nodes and node 2E 122.

In view of the foregoing, there is a need in the art for systems and methods to determine connectivity in a network more efficiently. Particularly, there is a need in the art for systems and method to perform connectivity mapping minimizing redundant and/or unnecessary queries. These and other needs are met by the present invention as detailed hereafter.

### SUMMARY OF THE INVENTION

The present invention is directed to systems and methods for improved mapping network connectivity. Redundant and unnecessary queries are reduced compared with a conventional network connectivity mapping algorithm, reducing the time cost of connectivity mapping. A table of connectivity of node types may be populated and managed to improve efficiency of the network connectivity mapping.

Tables of connectivity between nodes of two discrete types can be generated for edge nodes existing at the periphery of a network of nodes. Connectivity queries are initiated at one of an interior node type and then traverse in a first direction towards one edge node type and then in a second direction towards the other edge node type. The traversals to the second edge node type are skipped if it is determined that there is no connectivity to the nodes on the first type of edge nodes. In addition, check tables of known connectivity between node types may be populated so that the same connectivity traversal is not attempted more than once. The number of connectivity traversals and the associated time costs can be significantly reduced when compared to conventional connectivity mapping techniques.

A typical embodiment of the invention comprises a computer program embodied on a computer readable medium. The computer program includes program instructions for selecting an interior node type of at least three distinct node types in a network, program instructions for querying node connections to a first adjacent node type for each node of the selected interior node type, where the first adjacent node type is in a first direction, and program instructions for querying node connections to a second adjacent node type for each connected node of the selected interior node type, where each connected node of the selected interior node type is connected to a node of the first adjacent node type and where the second adjacent node type is in a second direction. Any connected nodes of the distinct node types may be connected in sequence across the distinct node types. In one exemplary embodiment, the network comprises a storage area network. Nodes of the network may comprise physical devices and/or logical devices.

In further embodiments of the invention, program instructions are included for querying connections for a plurality of first direction node types in the first direction in sequence such that only connected nodes are queried. Similarly, program instructions may also be included for querying connections for a plurality of second direction node types in the second direction in sequence such that only connected nodes are queried.

To facilitate execution of the connectivity mapping algorithm, any connections between connected nodes are compiled in one or more tables. For example, any connections between nodes of the interior node type and the first adjacent node type may be compiled in a first table. Similarly, any connections between connected nodes of the interior node type and the second adjacent node type are compiled in a second table.

A typical method embodiment of the invention comprises selecting an interior node type of at least three distinct node types in a network, querying node connections to a first adjacent node type for each node of the selected interior node type, where the first adjacent node type is in a first direction and querying node connections to a second adjacent node type for each connected node of the selected interior node type, where each connected node of the selected interior node type is connected to a node of the first adjacent node type and where the second adjacent node type is in a second direction. Further method embodiments of the invention may be developed consistent with the computer program embodiments of the invention.

### BRIEF DESCRIPTION OF THE DRAWINGS

Referring now to the drawings in which like reference numbers represent corresponding parts throughout:

FIG. 1A illustrates a typical connectivity mapping as known in the art;

FIG. 1B illustrates the operation of a conventional algorithm for connectivity mapping operating on the example network of FIG. 1A;

FIG. 2A illustrates an exemplary computer system that can be used to implement embodiments of the present invention;

FIG. 2B illustrates an exemplary network of computing devices that can be used with embodiments of the present invention;

FIG. 3A illustrates generalized connectivity mapping with an embodiment of the invention;

FIGS. 3B and 3C show a flowchart of a connectivity mapping process embodiment of the invention; and

FIG. 4 illustrates the operation of an exemplary algorithm of the invention for connectivity mapping operating on the example network of FIG. 1A.

### DETAILED DESCRIPTION OF THE PREFERRED EMBODIMENT

1. Overview

One aspect of the present invention involves efficiently generating a table of connectivity between nodes of two discrete types, that are defined as edge nodes existing at the periphery of a network of nodes. To illustrate, referring back to the example network of FIG. IA, nodes of type 1 102 and nodes of type 4 108 would be considered edge nodes. Any nodes that fall between these two types of edge nodes in the network may be defined as interior nodes. In the example, nodes of type 2 104 and type 3 106 are considered interior nodes. Embodiments of the invention may begin the connectivity traversals at one of the interior node types and then traverse first towards the first type of edge nodes (e.g., type 4 108) and then towards the second type of edge nodes (e.g., type 1 102). Other embodiments of the invention may traverse to more than just two types of edge nodes. In this sense, embodiments of the invention encompass a network having more than two adjacent directions and more than two edges from a selected interior node type. The traversals to the second type of edge nodes are skipped if it is determined that there is no connectivity to the nodes on the first type of edge nodes. By doing this, embodiments of the invention skip unnecessary connectivity traversals, providing an advantage over conventional connectivity mapping algorithms.

In addition, embodiments of the invention may populate and check tables of known connectivity between node types, so that the same connectivity traversal is not attempted more than once. By doing this, embodiments of the invention avoid many unnecessary connectivity traversals that conventional connectivity mapping algorithms would have attempted. Thus, embodiments of the invention never cross the same connectivity traversal twice. This can significantly reduce the number of connectivity traversals made and the associated time costs, when compared to conventional connectivity mapping algorithms.

2. Hardware Environment

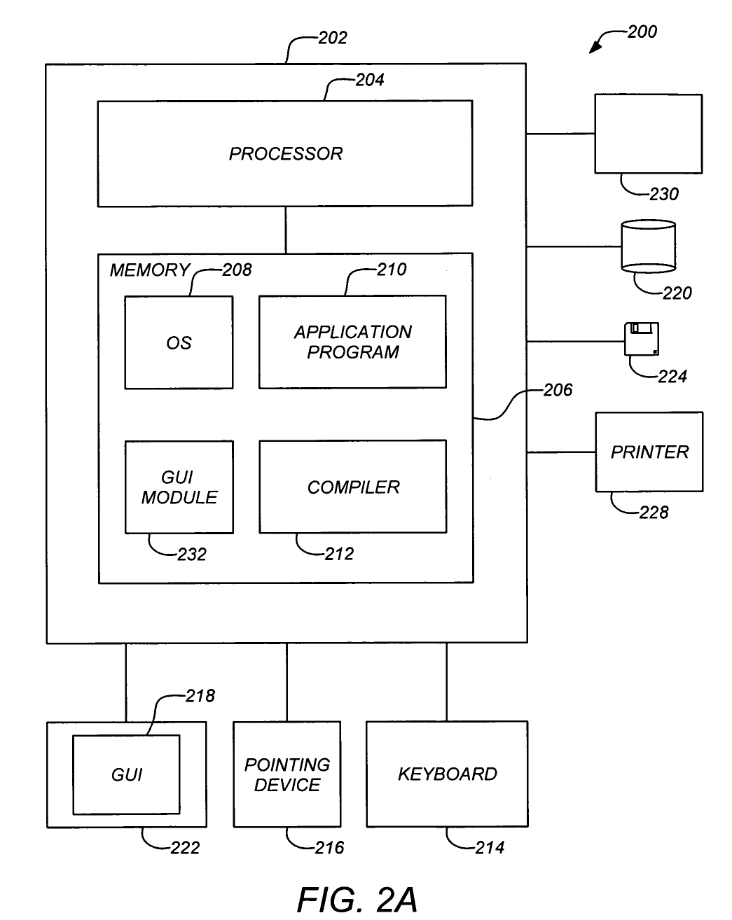

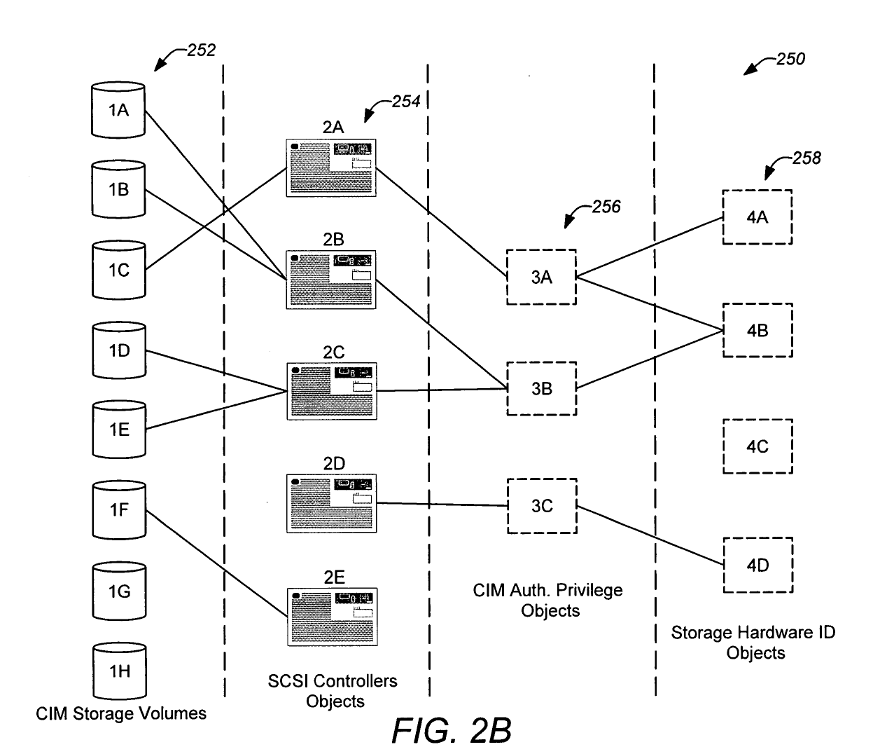

FIG. 2A illustrates an exemplary computer system 200 that can be used to implement embodiments of the present invention. The computer 202 comprises a processor 204 and a memory 206, such as random access memory (RAM). The computer 202 is operatively coupled to a display 222, which presents images such as windows to the user on a graphical user interface 218. The computer 202 may be coupled to other devices, such as a keyboard 214, a mouse device 216, a printer, etc. Of course, those skilled in the art will recognize that any combination of the above components, or any number of different components, peripherals, and other devices, may be used with the computer 202.

Generally, the computer 202 operates under control of an operating system 208 (e.g. z/OS, OS/2, LINUX, UNIX, WINDOWS, MAC OS) stored in the memory 206, and interfaces with the user to accept inputs and commands and to present results, for example through a graphical user interface (GUI) module 232. Although the GUI module 232 is depicted as a separate module, the instructions performing the GUI functions can be resident or distributed in the operating system 208, the computer program 210, or implemented with special purpose memory and processors. The computer 202 also implements a compiler 212 which allows an application program 210 written in a programming language such as COBOL, PL/1, C, C++, JAVA, ADA, BASIC, VISUAL BASIC or any other programming language to be translated into code that is readable by the processor 204. After completion, the computer program 210 accesses and manipulates data stored in the memory 206 of the computer 202 using the relationships and logic that was generated using the compiler 212. The computer 202 also optionally comprises an external data communication device 230 such as a modem, satellite link, ethernet card, wireless link or other device for communicating with other computers, e.g. via the Internet or other network.

In one embodiment, instructions implementing the operating system 208, the computer program 210, and the compiler 212 are tangibly embodied in a computer-readable medium, e.g., data storage device 220, which may include one or more fixed or removable data storage devices, such as a zip drive, floppy disc 224, hard drive, DVD/CD-rom, digital tape, etc., which are generically represented as the floppy disc 224. Further, the operating system 208 and the computer program 210 comprise instructions which, when read and executed by the computer 202, cause the computer 202 to perform the steps necessary to implement and/or use the present invention. Computer program 210 and/or operating system 208 instructions may also be tangibly embodied in the memory 206 and/or transmitted through or accessed by the data communication device 230. As such, the terms “article of manufacture,” “program storage device” and “computer program product” as may be used herein are intended to encompass a computer program accessible and/or operable from any computer readable device or media.

Embodiments of the present invention are generally directed to any software application program 210 that includes functions for managing a distributed computer system comprising a network of computing devices. The network may encompass one or more computers connected via a local area network and/or Internet connection (which may be public or secure, e.g. through a VPN connection), or via a Fibre Channel Storage Area Network or other known network types as will be understood by those skilled in the art.

FIG. 2B illustrates an exemplary network 250 of computing devices that can be used with embodiments of the present invention. In this example, the network comprises a storage area network (SAN) including a plurality of storage devices and controllers accessible by remote users. It is important to note that the network can include physical and/or logical devices (embodied within one or more physical devices), such as network objects used to control device access. Thus, although embodiments of the invention operate across a network of computing devices, e.g. computers 202, it is not necessary for each network node to comprise a single physical computing device. The example network 250 employs four distinct node types 252, 254, 256, 258. Type 1 252 nodes comprises volumes, e.g. CIM storage volumes. Type 2 104 nodes comprise CIM small computer standard interface (SCSI) protocol controller objects. Type 3 106 nodes comprise CIM authorized privilege objects. Type 4 108 nodes may represent known CIM storage hardware ID objects.

It is also important to understand that the node types 252, 254, 256, 258 also must be arranged according to certain requirements. First, the distinct node types 252, 254, 256, 258 correspond to a required connection sequence between nodes. Thus, nodes of a type N can only be connected to lower nodes of type N−1 in a first direction and upper nodes of type N+1 in a second (e.g. opposite) direction, where N is an integer. The node types can be thought of as layers where it is only possible for a node of a particular layer to be connected to a node of a lower layer one side and/or a node of an upper layer on the other side. For example, a type 1 node cannot skip type 2 nodes and connect directly to a type 3 node. In addition, in the example network 250 it is also possible to enumerate the instances of any type of node. Thus, all the nodes of a particular type are known or listed. As previously mentioned, the objective of connectivity mapping is to determine which nodes of type 1 252 at one end of the network 250 have a complete connection through to nodes of type 4 258 at the opposite end. These requirements of the network 250 structure coupled with the objective of the connectivity mapping provide the impetus for the connectivity mapping process of the present invention as will be detailed in the next section.

Those skilled in the art will recognize many modifications may be made to this hardware environment without departing from the scope of the present invention. For example, those skilled in the art will recognize that any combination of the above components, or any number of different components, peripherals, and other devices, may be used with the present invention meeting the functional requirements to support and implement various embodiments of the invention described herein.

3. Node Connectivity Mapping Algorithm

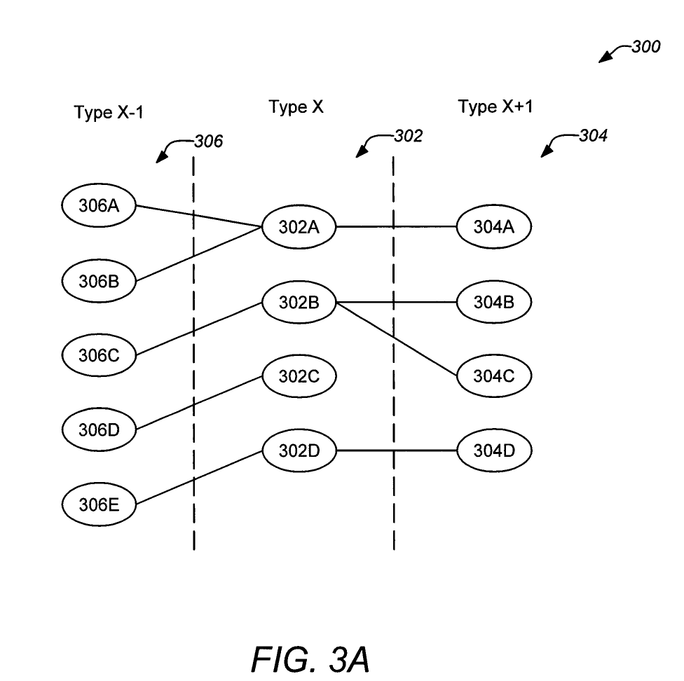

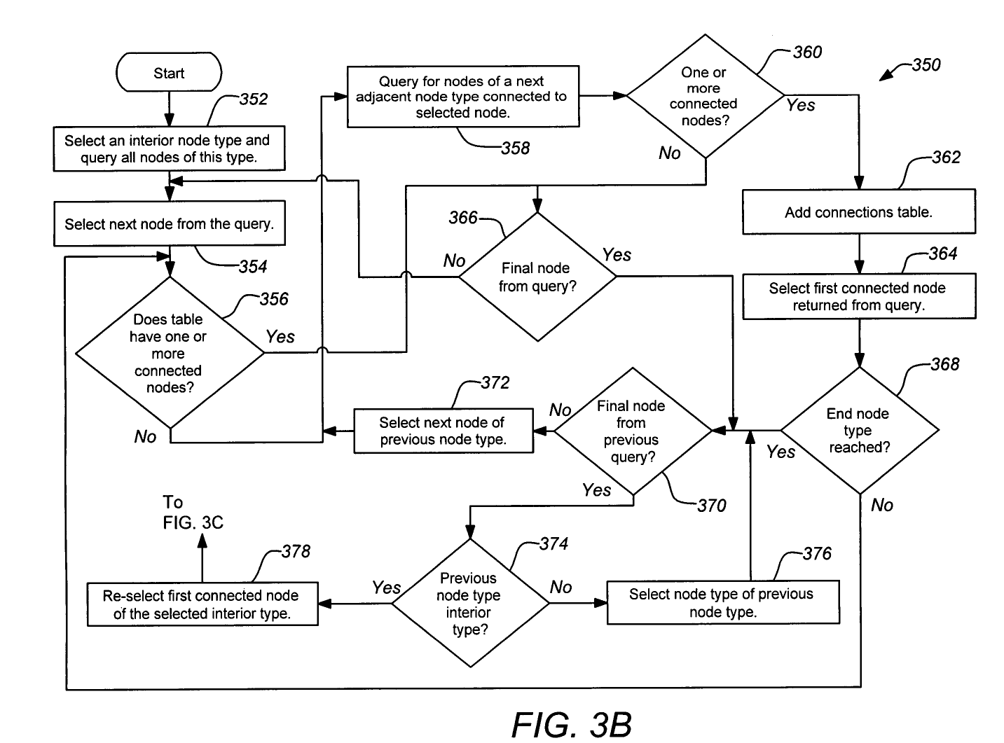

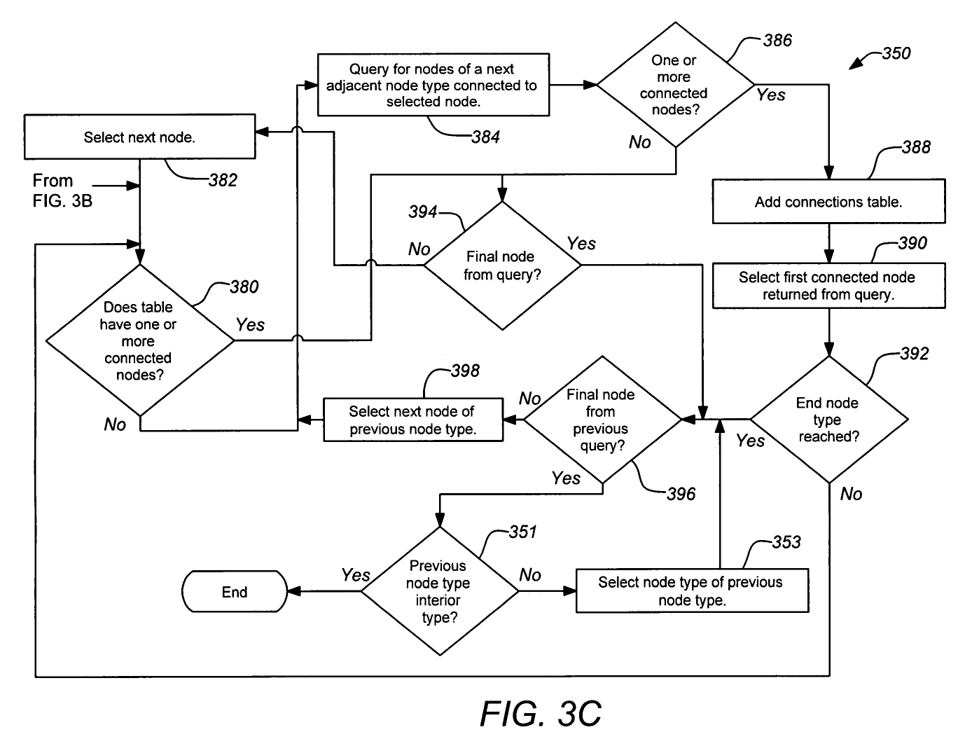

FIG. 3A illustrates generalized connectivity mapping of a network 300 with an embodiment of the invention. A node mapping algorithm according to the present invention operates and is useful under the following conditions. First, the algorithm operates when there are three or more discrete types of nodes. Although the example network 300 shows only three node types 302, 304, 306, any number of node types may be used. Thus, the any number of node types may be employed in a sequence generally denoted as: type 1, . . . type X−1, type X, type X+1, . . . type N, where X and N are integers. N is the total number of node types and X is an interior node type somewhere between the first node type 1 and the last node type N. Second, the node types connect to each other sequentially in order of the type of node. For example, type X−1 306 nodes can only connect to type X 302 nodes. Type X−1 306 nodes cannot skip type X 302 nodes and connect directly to type X+1 304 nodes. Thus, nodes of type X can only connect in a first direction to nodes of type X+1 and in a second (e.g. opposite) direction to nodes of type X−1. In general, the node types are sequenced beginning at a first node type 1 (type X−1 in the example network 300) and ending at a last node type (type X+1 in the example network 300). Third, there is a time cost associated with querying whether a node of type (e.g. X) is connected to zero or more nodes of an adjacent type (e.g. X+1 or X−1). It is possible to enumerate the instances of any type of node; the nodes of any node type are known.

As previously mentioned, distinct node types are arranged in a specified sequence, e.g. type X−1 306, type X 302, type X+1 304. Embodiments of the present invention capitalize on the fact that it is unecessary to follow connection traversals from a interior node in one direction if it is known that there is no connection in the opposite direction. Since the objective is to identify the nodes at the beginning of the network (type 1) that are connected through interior nodes to type N nodes at the end of the network, once it is determined that an interior node (e.g. type X node) is not connected to any type N nodes, it is not necessary to evalutate if any type 1 nodes are connected to the interior node.

An exemplary process of the invention can begin by enumerating the instances of a selected interior node type of the network. For example, assume that type X nodes are enumerated. For each instance of the type X nodes, 302A-302D the following processes are performed. Evaluate connectivity associations in a first direction from the selected interior node type, e.g. to node type X+1. Note that it is arbitrary which direction is evaluated first. This identifies the connected type X+1 nodes. If there are no connected type X+1 nodes, then the connectivity evaluations are restarted for the next type X node. If there are connected type X+1 nodes, add these connections to a table of type X to type X+1 connections, e.g. a table TConnX/X+1.

Following this, for each connected type X+1 node the following operations are performed. Check the table of connections between type X+1 and type X+2 (TConnX+1/X+2) for any known connections between the current type X+1 node and any type X+2 nodes. If at least one exists then the process moves to the next type X+1 node. If there is no known type X+2 nodes connected to this type X+1 node, then connectivity is queried in the same direction to determine any connected type X+2 nodes. Any connections are added to the TConn X+1/X+2 table. The connectivity evaluation will continue in the first direction until either the end node type, type N, is reached or no connections in the first direction are present.

Next, for each type X node that was determined to be connected to one or more type N nodes in the previous step, queries are performed to determine connectivity in a second direction from the current interior node. This will yield any connected type X−1 nodes. If there are no connected type X-1 nodes, then the connectivity evaluations are again restarted for the next type X node. If there are connected type X−1 nodes, these connections are added to a table of type X−1 to type X connections, e.g. TConn X−1/X. Here also, the connectivity evaluation continues in the second direction until either the first node type, type 1, is reached or a no connections in the second direction are present.

The result of the foregoing process yields a table for each pair of adjacent node types, e.g. TConn1/2, . . . TConnX−1/X, TConnX/X+1, . . . TConnN−1/N. (In the example showing only three node types only TConnX−1/X, TConnX/X+1 are generated.) These tables can be readily employed to determine the mapping between first type 1 nodes, e.g. type X−1 in the example, and the end type N nodes, e.g. type X+1 in the example, as shall be understood by those skilled in the art.

FIGS. 3B and 3C show a flowchart 350 of a connectivity mapping process embodiment of the invention. The process begins with the selection of an interior node type and a query for all nodes of this type to identify the list of nodes to be evaluated in operation 352. As previously discussed, an interior node type is a node type that exists somewhere between a first node type at one end and a last node type at another end. FIG. 3B is primarily focused on mapping connectivity from the selected interior node type to adjacent node types in a first direction from the selected interior node type. Similarly, FIG. 3C is primarily focused on mapping connectivity from the selected interior node type to adjacent node types in a second (e.g. opposite) direction from the selected interior node type. Connection mapping of the nodes of the selected interior node type to other nodes in a first direction from the selected interior node type are evaluated one by one in the sub-process FIG. 3B. The part of the process shown FIG. 3B continues as long as there are still interior nodes of the selected interior node type to be evaluated for connections nodes of the last node type (an end node type) in the first direction.

If there are, the next node of the selected interior node type is selected for connection mapping in operation 354. The corresponding connection table for the relevant node type is consulted for the presence of indicated connection in decision block 356. If the connection is already noted in the table, and it is not the last inner node, the process again returns to operation 354. If not, the node is then queried for further connections to any nodes of the next adjacent node type (in the first direction from the selected interior node type) as shown in operation 358. The query of operation 358 incurs a processing delay. Based on the results of the query in operation 358, if connections to one or more nodes of a next adjacent node type are found, as indicated in decision block 360, then they are added to the table in operation 362 and the first connected node returned from the query (of operation 358) is selected in operation 364. Following this, decision block 368 evaluates whether an end node type has been reached (in the first direction). If it has not, the process loops back to decision block 356 to evaluate the corresponding connection table and subsequent processing for the current selected node.

Looking to the alternative outcome of decision block 360, if there are no connected nodes found in the query of operation 358, the process and the final node from the query has not been reached (as determined in decision block 366), the process loops back to operation 354 to select the next node of the current node type being evaluated.

However, if either the final node from the query has been reached (as determined in decision block 366) or an end node type has been reached (as determined in decision block 368), the process then determines whether the final node from the previous query has been reached in decision block 370. If it has not, the process selects the next node of the previous node type in operation 372 and loops back to operation 358 to query for connected nodes of the next adjacent node type.

On the other hand, if the final node from the previous query has been reached (determined in decision block 370), the process checks whether the previous node type is the selected interior node type in decision block 374. If not, the node type of the previous node type is selected in operation 376 and process is returned to determine whether the final node from the previous query has been reached in decision block 370. In general, the “previous query” is not the most recent query from operation 358, but the query prior to that, which may have been either operation 358 or operation 354.

However, if the previous node type is the selected interior node type (determined in decision block 374), the first connected node of the selected of the selected interior node type is re-selected in operation 378 and the process then begins evaluating connection in a second direction as shown in FIG. 3C. The first “connected” node of the selected interior node type is the first node that is known (e.g. as shown in the connection tables) to have a connection in the first direction through to a node of an end node type.

The process of FIG. 3C is similar to that shown in FIG. 3B except that only nodes of the selected interior type that have already been determined in FIG. 3B to have connections through to a node of an end node type in the first direction will be evaluated in the process of FIG. 3C. There is no point in evaluating the selected interior type nodes that have no connections to a node of an end node type in the first direction. Thus, significant processing time can be save by avoiding unnecessary queries. All the processing shown in FIG. 3C that involves selecting the next node of the selected interior node type is limited to only those interior nodes known to have a connection through to a node of an end node type in the first direction.

The process of FIG. 3C for evaluating connections in the second direction begins with consulting the corresponding connection table for the relevant node type for the presence of an indicated connection in decision block 380. If the connection is already noted in the table, the process again returns to operation 382 to select the next node. If not, the node is then queried for further connections to any nodes of the next adjacent node type (in the second direction from the selected interior node type) as shown in operation 384, incurring a processing delay. Based on the results of the query in operation 384, if connections to one or more nodes of a next adjacent node type are found, as indicated in decision block 386, then they are added to the relevant table in operation 388 and the first connected node returned from the query (of operation 384) is selected in operation 390. Following this, decision block 392 evaluates whether an end node type has been reached in the second direction. If it has not, the process loops back to decision block 380 to evaluate the corresponding connection table and subsequent processing for the current selected node.

Looking to the alternative outcome of decision block 386, if there are no connected nodes found in the query of operation 384, the process and the final node from the query has not been reached (as determined in decision block 394), the process loops back to operation 382 to select the next node of the current node type being evaluated.

However, if either the final node from the query has been reached (as determined in decision block 394) or an end type node has been reached (as determined in decision block 392), the process then determines whether the final node from the previous query has been reached in decision block 396. If it has not, the process selects the next node of the previous node type in operation 398 and loops back to operation 384 to query for connected nodes of the next adjacent node type.

On the other hand, if the final node from the previous query has been reached (determined in decision block 396), the process checks whether the previous node type is the selected interior node type in decision block 351. If not, the node type of the previous node type is selected in operation 353 and process is returned to determine whether the final node from the previous query has been reached in decision block 396. If the previous node type is the selected interior node type (determined in decision block 351), the process ends and the network connectivity will be fully mapped as shown in the resulting set of tables.

The foregoing process 350 described in FIGS. 3B and 3C illustrates one exemplary embodiment of the invention. Variation of the operations and decisions and their arrangement will be apparent to those skilled in the art without departing from the scope of the invention. It should also be noted that although the given examples show networks having node types in only two directions leading to end node types, it will be understood by those skilled in the art that embodiments of the present invention are operable with for networks having distinct node types in more than two directions leading to more than two end node types.

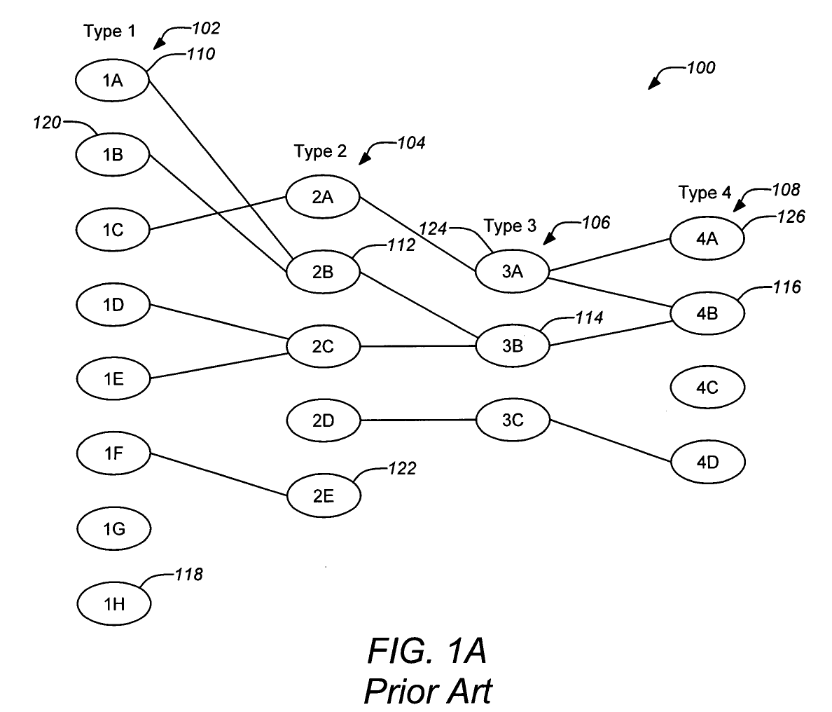

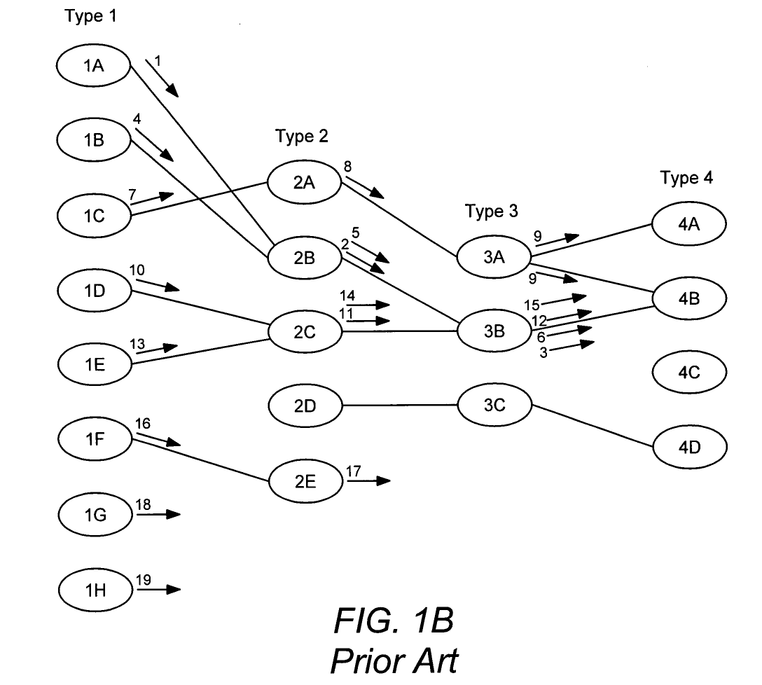

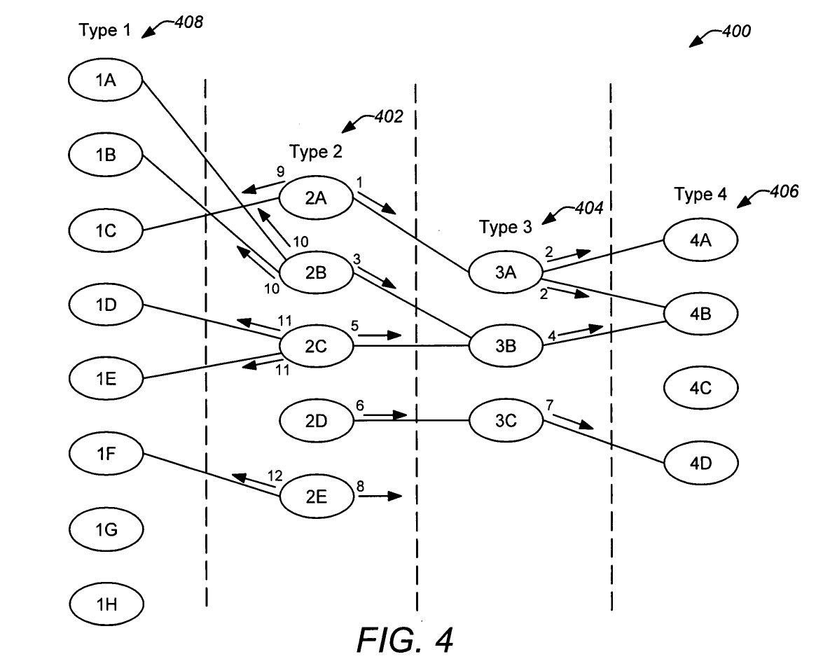

FIG. 4 illustrates the operation of an exemplary algorithm of the invention for connectivity mapping operating on the example network of FIG. 1A. Following the process described above, type 2 402 is first selected as the interior node type to evaluate. Each of the type 2 402 nodes 2A-2E are queried in order for any connections in a first direction (e.g. to the right) to any type 3 404 nodes 3A-3C as indicated by the numbered arrows identifying the order of the queries. If one or more connections are identified for a particular type 2 402 node to a type 3 404 node, the connected type 3 404 nodes are then queried for further connections in the first direction to any type 4 406 nodes. Any identified connections from type 3 404 nodes (that are only queried because they already have connections to at least one type 2 402 node) are then added to a table of type 3/type 4 connections because type 4 406 is the end node type. Similarly, the connection to the type 2 402 node is also added to a table of type 2/type 3 connections. For example, node 2A is queried for connections to any type 3 404 nodes. One is found to node 3A, so node 3A is then queried for connections to any type 4 406 nodes. When the two connections from node 3A to nodes 4A and 4B are identified, the connections of 3A-to-4A and 3A-to-4B are added to the type 3/type 4 table and the connection of 2A-to-3A is added to the type 2/type 3 table.

The process is repeated beginning from the next interior type 2 402 node until all interior type 2 402 connections have been evaluated in the first direction. Following this, the interior type 2 402 nodes are then evaluated in a similar manner for any connection in a second direction (e.g. to the left). However, only the type 2 402 nodes having connections through to type 4 406 nodes are evaluated, because it is unnecessary to check connections in the second direction if it is already known that no connection exists in the first direction. Any identified connections from type 2 402 to type 1 408 nodes are added to a type 1/type 2 connection table. Note that only one set of connections is evaluated in the second direction because type 1 408 is the first node type. As shown in FIG. 4, an embodiment of the invention incurs a cost of only twelve queries for determining the connectivity between type 1 and type 4 nodes.

As shown in the foregoing example, embodiments of the invention are particularly useful when there is a large number of edge nodes (e.g. type 1 nodes) that may have no connectivity at all. The algorithm avoids querying for the connectivity of each type 1 edge node for corresponding type 2 nodes. This is useful for determining host initiator access to volumes in the LUN Mapping and masking subprofile of SMI-S, because often there are a great number of type 1 nodes (e.g. volumes, such as CIM storagevolumes) that have no connectivity to type 2 nodes. For example, if a network employed 2,000 type 1 nodes where only ten of them are connected to type 2 nodes, the algorithm would save approximately 1,990 queries.

This concludes the description including the preferred embodiments of the present invention. The foregoing description including the preferred embodiment of the invention has been presented for the purposes of illustration and description. It is not intended to be exhaustive or to limit the invention to the precise forms disclosed. Many modifications and variations are possible within the scope of the foregoing teachings. Additional variations of the present invention may be devised without departing from the inventive concept as set forth in the following claims.

What is claimed is:

1. A computer program embodied on a computer readable medium, comprising:
program instructions for selecting an interior node type of at least three distinct node types in a network;
program instructions for querying node connections to a first adjacent node type for each node of the selected interior node type, where the first adjacent node type is in a first direction; and
program instructions for querying node connections to a second adjacent node type for each connected node of the selected interior node type, where each connected node of the selected interior node type is connected to a node of the first adjacent node type and where the second adjacent node type is in a second direction.

2. The computer program of claim 1, wherein any connected nodes of the distinct node types are connected in sequence across the distinct node types.

3. The computer program of claim 1, wherein the network comprises a storage area network.

4. The computer program of claim 1, wherein nodes of the network comprise physical devices.

5. The computer. program of claim 1, wherein nodes of the network comprise logical devices.

6. The computer program of claim 1, further comprising program instructions for querying connections for a plurality of first direction node types in the first direction in sequence such that only connected nodes are queried.

7. The computer program of claim 1, further comprising program instructions for querying connections for a plurality of second direction node types in the second direction in sequence such that only connected nodes are queried.

8. The computer program of claim 1, wherein any connections between connected nodes are compiled in one or more tables.

9. The computer program of claim 8, wherein any connections between the interior node type and the first adjacent node type are compiled in a first table.

10. The computer program of claim 8, wherein any connections between connected nodes of the interior node type and the second adjacent node type are compiled in a second table.

11. A method, comprising:
selecting an interior node type of at least three distinct node types in a network;
querying node connections to a first adjacent node type for each node of the selected interior node type, where the first adjacent node type is in a first direction; and
querying node connections to a second adjacent node type for each connected node of the selected interior node type, where each connected node of the selected interior node type is connected to a node of the first adjacent node type and where the second adjacent node type is in a second direction.

12. The method of claim 11, wherein any connected nodes of the distinct node types are connected in sequence across the distinct node types.

13. The method of claim 11, wherein the network comprises a storage area network.

14. The method of claim 11, wherein nodes of the network comprise physical devices.

15. The method of claim 11, wherein nodes of the network comprise logical devices.

16. The method of claim 11, further comprising querying connections for a plurality of first direction node types in the first direction in sequence such that only connected nodes are queried.

17. The method of claim 11, further comprising querying connections for a plurality of second direction node types in the second direction in sequence such that only connected nodes are queried.

18. The method of claim 11, wherein any connections between connected nodes are compiled in one or more tables.

19. The method of claim 18, wherein any connections between the interior node type and the first adjacent node type are compiled in a first table.

20. The method of claim 18, wherein any connections between connected nodes of the interior node type and the second adjacent node type are compiled in a second table.
